(19) United States
(12) Patent Application Publication
(10) Pub. No.: US 2025/0055140 A1
(43) Pub. Date: Feb. 13, 2025

(54) SECONDARY BATTERY

(71) Applicant: Panasonic Energy Co., Ltd., Osaka (JP)

(72) Inventors: Shunsuke NAMBUYA, Osaka (JP); Shuichi TSUNODA, Hyogo (JP)

(21) Appl. No.: 18/708,470

(22) PCT Filed: Nov. 15, 2022
(86) PCT No.: PCT/JP2022/042444

§ 371 Date: May 8, 2024

(30) Foreign Application Priority Data
Nov. 30, 2021 (JP) 2021-194184

(51) Int. Cl. H01M 50/489; H01M 4/02; H01M 10/0587; H01M 50/449; H01M 50/595

(52) U.S. Cl. CPC H01M 50/489; H01M 10/0587; H01M 50/449; H01M 50/595; H01M 2004/027; H01M 2004/028

(57) ABSTRACT

Provided is a secondary battery in which: at least a portion of a first outermost peripheral tape opposes a first end portion heat resistant layer; at least a portion of a second outermost peripheral tape opposes a second end portion heat resistant layer; and a ratio (A1/W) of a length (A1) from one end, in a width direction, of a separator to a central side end portion, in the width direction, of the first outermost peripheral tape to a length (W), in the width direction, of the separator, and a ratio (A2/W) of a length (A2) from the other end, in the width direction, of the separator to a central side end portion, in the width direction, of the second outermost peripheral tape to the length (W), in the width direction, of the separator are each at most equal to 0.25.

### CROSS-REFERENCE OF RELATED APPLICATIONS

This application is the U.S. National Phase under 35 U.S.C. § 371 of International Patent Application No. PCT/JP2022/042444, filed on Nov. 15, 2022, which in turn claims the benefit of Japanese Patent Application No. 2021-194184, filed on Nov. 30, 2021, the entire disclosures of which Applications are incorporated by reference herein.

### TECHNICAL FIELD

The present disclosure relates to a secondary battery.

### BACKGROUND

Recently, as high output and high energy density secondary batteries, non-aqueous electrolyte secondary batteries including a winding electrode assembly in which a positive electrode and a negative electrode are wound with a separator interposed therebetween have been widely utilized.

For example, Patent Literatures 1 and 2 disclose a non-aqueous electrolyte secondary battery using a separator having a heat resistant layer.

### CITATION LIST

### Patent Literatures

Patent Literature 1: JP 2009-143060 A
Patent Literature 2: JP 2013-118057 A

### SUMMARY

In a secondary battery using a winding electrode assembly, for example, a tape is wound around an outermost peripheral surface of an electrode assembly in order to fix a member constituting the electrode assembly. However, when charging and discharging of the secondary battery are repeated, a member forming the outermost peripheral surface of the electrode assembly (negative electrode, positive electrode, or separator) may be cut at an end (edge) of the tape. The cut member on the outermost peripheral surface of the electrode assembly becomes a short-circuit risk. Even when the member forming the outermost peripheral surface of the electrode assembly is not cut, for example, the short-circuit risk may increase due to negative electrode expansion at the center of the electrode assembly due to reaction unevenness of the electrode assembly.

Therefore, an object of the present disclosure is to provide a secondary battery capable of suppressing member breakage of an outermost peripheral surface of an electrode assembly due to repetition of charging and discharging, and further reducing a short-circuit risk.

A non-aqueous electrolyte secondary battery according to an aspect of the present disclosure includes: a winding electrode assembly formed by winding a positive electrode and a negative electrode with a separator interposed between the positive electrode and the negative electrode; and an outermost peripheral tape attached to an outermost peripheral surface of the electrode assembly to straddle a winding terminal end of the electrode assembly, in which the separator has a substrate layer and a heat resistant layer disposed on at least one surface of the substrate layer, the heat resistant layer has a first end heat resistant layer having a predetermined width from one end, in a width direction, of the separator along a winding axis direction of the electrode assembly to a central side, a second end heat resistant layer having a predetermined width from the other end, in the width direction, of the separator along the winding axis direction of the electrode assembly to the central side, and a central heat resistant layer interposed between the first end heat resistant layer and the second end heat resistant layer, the outermost peripheral tape has a first outermost peripheral tape disposed on one end side, in the winding axis direction, of the electrode assembly and a second outermost peripheral tape disposed on the other end side, in the winding axis direction, of the electrode assembly, at least a part of the first outermost peripheral tape faces the first end heat resistant layer and at least a part of the second outermost peripheral tape faces the second end heat resistant layer, a thickness (Y1) of the first end heat resistant layer and a thickness (Y2) of the second end heat resistant layer are thinner than a thickness (Z) of the central heat resistant layer and thicker than 0.001 mm, and a ratio (A1/W) of a length (A1) from one end, in the width direction, of the separator to a central side end, in the width direction, of the first outermost peripheral tape to a length (W), in the width direction, of the separator, and a ratio (A2/W) of a length (A2) from the other end, in the width direction, of the separator to a central side end, in the width direction, of the second outermost peripheral tape to the length (W), in the width direction, of the separator are each less than or equal to 0.25.

According to the present disclosure, it is possible to suppress member breakage of an outermost peripheral surface of an electrode assembly due to repetition of charging and discharging, and further reduce a short-circuit risk.

### BRIEF DESCRIPTION OF DRAWINGS

FIG. 1 is a schematic cross-sectional view of a non-aqueous electrolyte secondary battery as an example of an embodiment.

FIG. 2 is a schematic perspective view illustrating an example of a winding electrode assembly.

FIG. 3 is a schematic plan view illustrating an example of a separator before being wound around an electrode assembly.

FIG. 4 is a schematic cross-sectional view of the separator taken along line L1-L1 in FIG. 3.

FIG. 5 is a partial schematic cross-sectional view for describing a state where a separator of the winding electrode assembly illustrated in FIG. 2 and an outermost peripheral tape face each other.

### DESCRIPTION OF EMBODIMENTS

Hereinafter, a non-aqueous electrolyte secondary battery will be described as an example of a secondary battery of the present disclosure. However, the secondary battery of the present disclosure is not limited to the following non-aqueous electrolyte secondary battery, and is applied to various secondary batteries without departing from the technical idea of the present disclosure.

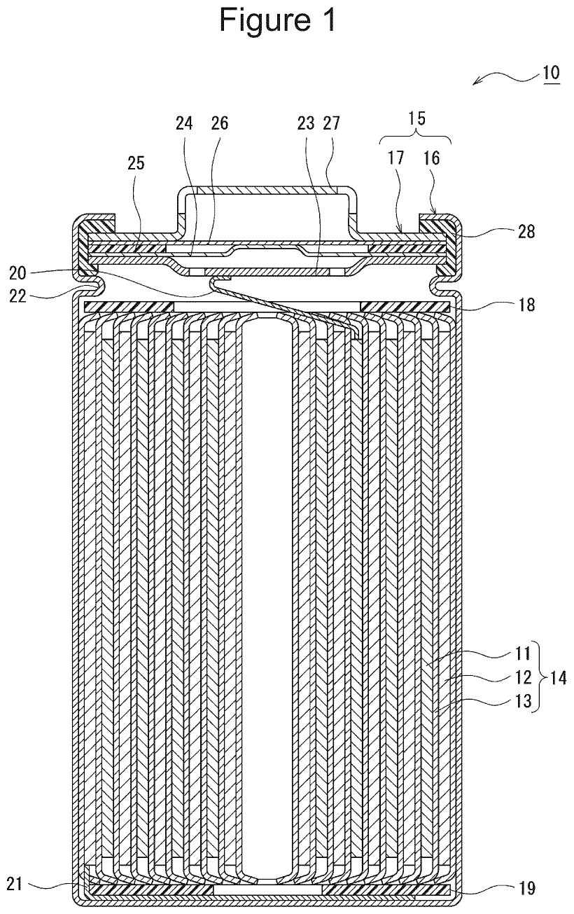

FIG. 1 is a schematic cross-sectional view of a non-aqueous electrolyte secondary battery as an example of an embodiment. A non-aqueous electrolyte secondary battery 10 illustrated in FIG. 1 includes a winding electrode assembly 14 formed by winding a positive electrode 11 and a negative electrode 12 with a separator 13 interposed therebetween, a non-aqueous electrolyte, insulating plates 18 and 19 each disposed above and under the electrode assembly 14, and a battery case 15 accommodating the members described above. The battery case 15 is composed of a bottomed cylindrical case body 16 and a sealing assembly 17 blocking an opening of the case body 16. Examples of the battery case 15 include metal cases such as cylindrical and rectangular cases, and resin cases formed by laminating a resin sheet (so-called laminate type).

The case body 16 is, for example, a bottomed cylindrical metal container. A gasket 28 is provided between the case body 16 and the sealing assembly 17 to achieve hermeticity inside the battery. The case body 16 has, for example, a projecting portion 22 supporting the sealing assembly 17, at which a portion of the side wall projects inward. The projecting portion 22 is preferably formed along a peripheral direction of the case body 16 in an annular shape and supports the sealing assembly 17 on an upper surface thereof.

The sealing assembly 17 has a structure in which a filter 23, a lower vent member 24, an insulating member 25, an upper vent member 26, and a cap 27 are laminated from the side of the electrode assembly 14. The members constituting the sealing assembly 17 each have, for example, a disk shape or a ring shape, and the members except for the insulating member 25 are each electrically connected to one another. The lower vent member 24 and the upper vent member 26 are connected at each center to each other, and the insulating member 25 is interposed between the peripheral edges of the vent members. When the internal pressure of the non-aqueous electrolyte secondary battery 10 increases by heat generation due to an internal short circuit or the like, for example, the lower vent member 24 deforms and breaks so as to push up the upper vent member 26 toward the side of the cap 27, and a cu path between the lower vent member 24 and the upper vent member 26 is disconnected. When the internal pressure further increases, the upper vent member 26 breaks, and gas is emitted from an opening of the cap 27.

In the non-aqueous electrolyte secondary battery 10 illustrated in FIG. 1, a positive electrode lead 20 attached to the positive electrode 11 extends through a through-hole in the insulating plate 18 to the side of the sealing assembly 17, and a negative electrode lead 21 attached to the negative electrode 12 extends through outside the insulating plate 19 to the side of the bottom of the case body 16. The positive electrode lead 20 is connected to a lower surface of the filter 23, which is a bottom plate of the sealing assembly 17, by welding or the like, and the cap 27, which is a top plate of the sealing assembly 17 electrically connected to filter 23 serves as a positive electrode terminal. The negative electrode lead 21 is connected to an inner surface of the bottom of the case body 16 by welding or the like, and the case body 16 serves as a negative electrode terminal.

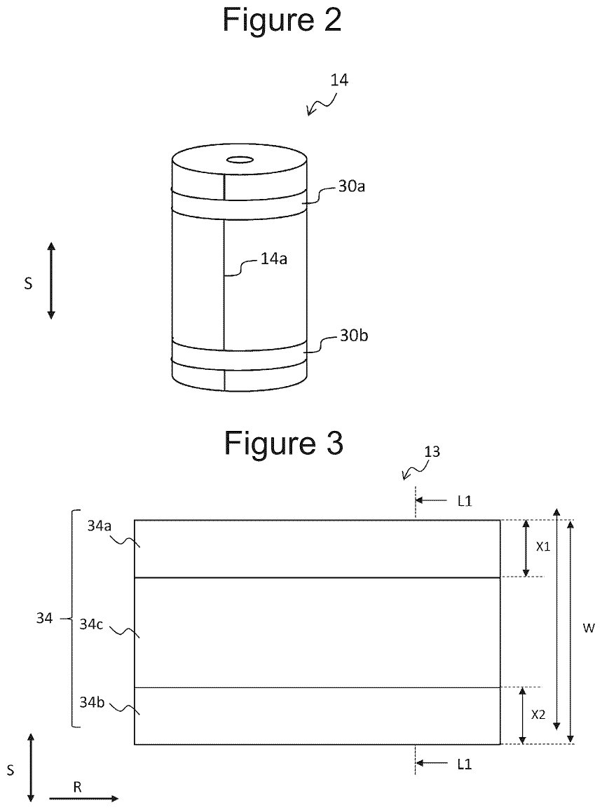

FIG. 2 is a schematic perspective view illustrating an example of a winding electrode assembly. The electrode assembly 14 is formed by interposing the separator 13 between the positive electrode 11 and the negative electrode 12 and winding these members. A winding terminal end 14a of the electrode assembly 14 exists on the outermost peripheral surface of the electrode assembly 14. The winding terminal end 14a of the electrode assembly 14 is an end of winding end of the members (the positive electrode 11, the negative electrode 12, and the separator 13) of the electrode assembly 14 on the outermost peripheral surface of the electrode assembly 14. For example, in order to bring the negative electrode current collector constituting the negative electrode 12 into contact with the case body 16, the negative electrode 12 (substantially the negative electrode current collector) may be wound one turn or more longer from the end of winding end of the positive electrode 11 and the separator 13 to use the outermost peripheral surface of the electrode assembly 14 as the negative electrode 12, but in this case, the end of winding end of the negative electrode 12 becomes the winding terminal end 14a of the electrode assembly 14. For example, when the ends of winding end of the positive electrode 11, the negative electrode 12, and the separator 13 are located at different positions on the outermost peripheral surface of the electrode assembly 14, each end of winding becomes the winding terminal end 14a of the electrode assembly 14 (that is, three winding terminal ends 14a exist on the outermost peripheral surface of the electrode assembly 14).

The non-aqueous electrolyte secondary battery 10 has a first outermost peripheral tape 30a and a second outermost peripheral tape 30b attached to the outermost peripheral surface of the electrode assembly 14 to straddle the winding terminal end 14a of the electrode assembly 14. The first outermost peripheral tape 30a is disposed on one end side, in a winding axis direction (arrow S shown in FIG. 2), of the electrode assembly 14. As illustrated in FIG. 2, the first outermost peripheral tape 30a may be disposed with a predetermined gap from one end, in the winding axis direction, of the electrode assembly 14, and may be disposed close to one end, in the winding axis direction, of the electrode assembly 14 without a gap. The second outermost peripheral tape 30b is disposed on the other end side, in the winding axis direction, of the electrode assembly 14. As illustrated in FIG. 2, the second outermost peripheral tape 30b may be disposed with a predetermined gap from the other end, in the winding axis direction, of the electrode assembly 14, and may be disposed close to one end, in the winding axis direction, of the electrode assembly 14 without a gap. Hereinafter, the outermost peripheral tapes (30a and 30b) refer to both the first outermost peripheral tape 30a and the second outermost peripheral tape 30b.

When the outermost peripheral tapes (30a and 30b) are attached to straddle the winding terminal end 14a of the electrode assembly 14, a member constituting the electrode assembly 14 is fixed. That is, the positive electrode 11, the negative electrode 12, and the separator 13 which have been wound are not unwound, and the wound state is maintained. In order to more strongly fix a member constituting the electrode assembly 14, it is desirable that the outermost peripheral tapes (30a and 30b) go around the outermost peripheral surface of the electrode assembly 14 one or more time. As the outermost peripheral tapes (30a and 30b), for example, a conventionally known tape used for a winding electrode assembly is applied.

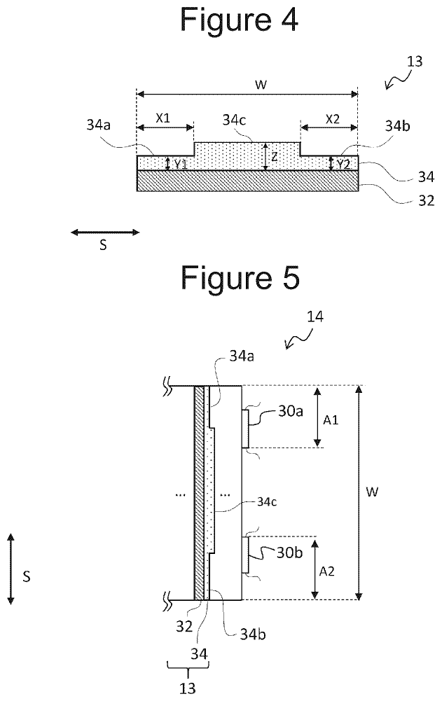

FIG. 3 is a schematic plan view of a separator before being wound around an electrode assembly, and FIG. 4 is a schematic cross-sectional view of the separator taken along line L1-L1 in FIG. 3. Arrow S shown in the drawing indicates the winding axis direction of the electrode assembly 14, and arrow R orthogonal to arrow S indicates a winding direction of the separator 13 (that is, winding direction of a member constituting the electrode assembly 14).

As illustrated in FIG. 4, the separator 13 has a substrate layer 32 and a heat resistant layer 34 disposed on one surface of the substrate layer 32. The heat resistant layer 34 is not limited to be disposed on one surface of the substrate layer 32, and may be disposed on both surfaces of the substrate layer 32. When the electrode assembly 14 is produced using the separator in which the heat resistant layer 34 is disposed on one surface of the substrate layer 32, the separator 13 and the positive electrode 11 are preferably overlapped such that the heat resistant layer 34 faces the positive electrode 11 from the viewpoint of improving the charge-discharge cycle characteristics and safety of the battery, and the like. The separator 13 may be designed to have a larger width and length than those of the positive electrode 11 and the negative electrode 12 in order to prevent a short circuit between the positive and negative electrodes. In this case, when the positive electrode 11, the negative electrode 12, and the separator 13 are overlapped at the time of producing the electrode assembly 14, the separator 13 protrudes from the positive electrode 11 or the negative electrode 12.

As illustrated in FIGS. 3 and 4, the heat resistant layer 34 has a first end heat resistant layer 34a having a predetermined width from one end, in the width direction, of the heat resistant layer 34 along the winding axis direction of the electrode assembly 14 to the central side, a second end heat resistant layer 34b having a predetermined width from the other end, in the width direction, of the heat resistant layer 34 along the winding axis direction of the electrode assembly 14 to the central side, and a central heat resistant layer 34c interposed between the first end heat resistant layer 34a and the second end heat resistant layer 34b.

FIG. 5 is a partial schematic cross-sectional view for describing a state where a separator of the winding electrode assembly illustrated in FIG. 2 and an outermost peripheral tape face each other. In the winding electrode assembly 14, the positive electrode 11, the negative electrode 12, and the separator 13 are laminated in a direction orthogonal to the winding axis direction (arrow S) of the electrode assembly 14, but in FIG. 5, for the sake of convenience, these members are omitted, and only one of the laminated separators 13 and the outermost peripheral tapes (30a and 30b) attached to the outermost peripheral surface of the electrode assembly 14 are shown.

As illustrated in FIG. 5, at least a part of the first outermost peripheral tape 30a faces the first end heat resistant layer 34a of the separator 13, and at least a part of the second outermost peripheral tape 30b faces the second end heat resistant layer 34b of the separator 13. Heat, the phrase “at least a part of the outermost peripheral tape (30a, 30b) faces the first end heat resistant layer 34a or the second end heat resistant layer 34b” means a state where at least a part of a projection region when the first outermost peripheral tape 30a is projected on the separator 13 overlaps at least a part of the first end heat resistant layer 34a, and a state where at least a part of a projection region when the second outermost peripheral tape 30b is projected on the separator 13 overlaps at least a part of the second end heat resistant layer 34b.

With reference to FIGS. 3 and 4, a thickness (Y1) of the first end heat resistant layer 34a and a thickness (Y2) of the second end heat resistant layer 34b are each thinner than a thickness (Z) of the central heat resistant layer 34c and thicker than 0.001 mm. With reference to FIG. 5, the ratio (A1/W) of a length (A1) from one end, in the width direction, of the separator 13 to the central side end, in the width direction, of the first outermost peripheral tape 30a to a length (W), in the width direction, of the separator 13 along the winding axis direction (arrow S) of the electrode assembly 14, and the ratio (A2/W) of a length (A2) from the other end, in the width direction, of the separator 13 to the central side end, in the width direction, of the second outermost peripheral tape 30b to the length (W), in the width direction, of the separator 13 along the winding axis direction of the electrode assembly 14 are each less than or equal to 0.25. With this configuration, the pressure at the ends (edges) of the first outermost peripheral tape 30a facing the first end heat resistant layer 34a and the second outermost peripheral tape 30b facing the second end heat resistant layer 34b is reduced. As a result, even when charging and discharging are repeated, breakage of a member (the positive electrode 11, the negative electrode 12, or the separator 13) forming the outermost peripheral surface of the electrode assembly 14 at the end of the outermost peripheral tape (30a, 30b) is suppressed. The negative electrode expansion at the center of the electrode assembly due to reaction unevenness of the electrode assembly 14 is suppressed. Thus, from these points, the short-circuit risk is reduced. When the thickness (Y1) of the first end heat resistant layer 34a and the thickness (Y2) of the second end heat resistant layer 34b are each set to less than or equal to 0.001 mm, for example, an internal short circuit may occur due to separator contraction caused by a decrease in heat resistance of the separator 13.

A ratio (Z/Y1) of the thickness (Z) of the central heat resistant layer 34c to the thickness (Y1) of the first end heat resistant layer 34a, and a ratio (Z/Y2) of the thickness (Z) of the central heat resistant layer 34c to the thickness (Y2) of the second end heat resistant layer 34b are each preferably greater than or equal to 1.4. When Z/Y1 and Z/Y2 are each greater than or equal to 1.4, as compared with a case where Z/Y1 and Z/Y2 are each less than 1.4, breakage of a member forming the outermost peripheral surface of the electrode assembly 14 is further suppressed at the end of the outermost peripheral tape (30a, 30b) and the short-circuit risk may be further reduced.

The thickness (Z) of the central heat resistant layer 34c is preferably greater than or equal to 0.0045 mm. When the thickness (Z) of the central heat resistant layer 34c is greater than or equal to 0.0045 mm, as compared with a case where the thickness (Z) is less than 0.0045 mm, the heat resistance of the separator 13 can be improved. When the negative electrode expansion at the center of the electrode assembly increases due to electrode reaction unevenness, the short-circuit risk may increase, but when the thickness of the central heat resistant layer 34c is increased and preferably set to greater than or equal to 0.0045 mm, the negative electrode expansion at the center of the electrode assembly can be reduced.

At least a part of the first outermost peripheral tape 30a may face the first end heat resistant layer 34a and at least a part of the second outermost peripheral tape 30b may face the second end heat resistant layer 34b, but it is preferable that the entire first outermost peripheral tape 30a faces the first end heat resistant layer 34a and the entire second outermost peripheral tape 30b faces the second end heat resistant layer 34b. As a result, breakage of a member forming the outermost peripheral surface of the electrode assembly 14 is further suppressed at the end of the outermost peripheral tape (30a, 30b) and the short-circuit risk may be further reduced. Heat, the phrase “the entire outermost peripheral tape (30a, 30b) faces the first end heat resistant layer 34a or the second end heat resistant layer 34b” means a state where the entire projection region when the first outermost peripheral tape 30a is projected on the separator 13 overlaps at least a part of the first end heat resistant layer 34a, and a state where the entire projection region when the second outermost peripheral tape 30b is projected on the separator 13 overlaps at least a part of the second end heat resistant layer 34b.

With reference to FIGS. 3 and 4, a ratio (X1/W) of a length (X1) of the predetermined width of the first end heat resistant layer 34a to the length (W), in the width direction, of the separator 13, and a ratio (X2/W) of a length (X2) of the predetermined width of the second end heat resistant layer 34b to the length (W), in the width direction, of the separator 13 are each preferably less than or equal to 0.25 and more preferably greater than or equal to 0.10 and less than or equal to 0.25. When X1/W and X2/W are each greater than or equal to 0.10 and less than or equal to 0.25, as compared with a case where X1/W and X2/W are each greater than 0.25, for example, the heat resistance of the separator 13 may be improved. When X1/W and X2/W are each greater than or equal to 0.10 and less than or equal to 0.25, as compared with a case where X1/W and X2/W are each less than 0.10, breakage of a member forming the outermost peripheral surface of the electrode assembly 14 is further suppressed at the end of the outermost peripheral tape (30a, 30b) even when charging and discharging are repeated, and the short-circuit risk may be further reduced.

The substrate layer 32 is, for example, configured by a porous substrate, and specifically, configured by a microporous thin film, a woven fabric, a nonwoven fabric, or the like. The material of the substrate layer 32 is not particularly limited, and examples thereof include polyethylene, polypropylene, polyolefins such as a copolymer of polyethylene and α-olefin, an acrylic resin, polystyrene, polyester, and cellulose. The substrate layer 32 may have a single layer structure or a laminated structure. The thickness of the substrate layer 32 is not particularly limited, and is, for example, preferably in a range of greater than or equal to 3 μm and less than or equal to 20 μm.

The average pore size of the substrate layer 32 is, for example, preferably in a range of greater than or equal to 0.02 μm and less than or equal to 0.5 μm and more preferably in a range of greater than or equal to 0.03 μm and less than or equal to 0.3 μm. The average pore size of the substrate layer 32 is measured using a Perm-Porometer (manufactured by SEIKA CORPORATION), which can perform pore size measurements using a bubble point method (JIS K 3832, ASTM F316-86).

The porosity of the substrate layer 32 is, for example, preferably in a range of greater than or equal to 30% and less than or equal to 80% in terms of ion permeability and the like. The porosity of the substrate layer 32 is calculated by the following formula.

Porosity (%)={(Apparent volume of substrate layer-Actual volume of component of substrate layer)=(Apparent volume of substrate layer)}×100

Apparent volume of substrate layer=Measured thickness of substrate layer×Area

Actual volume of substrate layer=Mass of component contained in substrate layer=True density

The heat resistant layer 34 contains, for example, a filler and a resin. When the heat resistant layer 34 contains a filler, for example, a heat shrinkage suppressing effect can be imparted to the heat resistant layer 34. The melting point or thermal softening point of the filler is, for example, preferably greater than or equal to 150° C. and more preferably greater than or equal to 200° C. Examples of the filler include metal oxide particles, metal nitride particles, metal fluoride particles, and metal carbide particles. Examples of the metal oxide particles include aluminum oxide, titanium oxide, magnesium oxide, zirconium oxide, nickel oxide, silicon oxide, and manganese oxide. Examples of the metal nitride particles include titanium nitride, boron nitride, aluminum nitride, magnesium nitride, and silicon nitride. Examples of the metal fluoride particles include aluminum fluoride, lithium fluoride, sodium fluoride, magnesium fluoride, calcium fluoride, and barium fluoride. Examples of the metal carbide particles include silicon carbide, boron carbide, titanium carbide, and tungsten carbide. The filler may be a porous aluminosilicate such as zeolite (M_{2/n}O·Al₂O₃·XSiO₂·yH₂O, M is a metal element, x≥2, y≥0), a layered silicate such as talc (Mg₃Si₄O₁₀(OH)₂), a mineral such as barium titanate (BaTiO₃) or strontium titanate (SrTiO₃), and the like. These may be used alone or in combination of two or more kinds thereof.

The BET specific surface area of the filler is not particularly limited, and is, for example, preferably in a range of greater than or equal to 1 m²/g and less than or equal to 20 m²/g and more preferably in a range of greater than or equal to 3 m²/g and less than or equal to 15 m²/g. The average particle diameter of the filler is not particularly limited, and is, for example, preferably greater than or equal to 0.1 μm and less than or equal to 5 μm and more preferably in a range of greater than or equal to 0.2 μm and less than or equal to 1 μm.

The content of the filler is, for example, preferably in a range of greater than or equal to 70 mass % and less than or equal to 95 mass with respect to the total mass of the heat resistant layer 34.

The resin preferably has a function as a binder for bonding the fillers to each other and the filler to the substrate layer. Examples of the resin include fluorine-based resins such as polyvinylidene fluoride (PVDF) and polytetrafluoroethylene (PTFE), a polyimide-based resin, an acryl-based resin, and a polyolefin-based resin. These may be used alone or in combination of two or more kinds thereof.

The content of the resin is, for example, preferably in a range of greater than or equal to 5 mass % and less than or equal to 15 mass % with respect to the total mass of the heat resistant layer 34.

An example of a method for producing the separator 13 will be described. For example, a slurry for a heat resistant layer containing a filler and a resin is prepared. The slurry is applied to the entire surface of the substrate layer 32 and then dried to form the heat resistant layer 34 on the entire surface of the substrate layer 32. The slurry is applied to a center, in the width direction, of the heat resistant layer 34 along a longitudinal direction of the heat resistant layer 34 and then dried. As a result, the separator 13 is obtained in which the central heat resistant layer 34c having a thickness at the center, in the width direction, of the heat resistant layer 34 and the first end heat resistant layer 34a and the second end heat resistant layer 34b having thin thicknesses at both ends, in the width direction, of the heat resistant layer 34 are formed on the substrate layer 32.

The positive electrode 11 includes, for example, a positive electrode current collector and a positive electrode active material layer provided on the positive electrode current collector. As the positive electrode current collector, for example, a foil of a metal such as aluminum which is stable in a potential range of the positive electrode, a film in which the metal is disposed on a surface layer, or the like can be used. The positive electrode active material layer contains a positive electrode active material, and preferably contains a conductive agent or a binder.

Examples of the positive electrode active material include lithium transition metal composite oxides, and specifically, lithium cobaltate, lithium manganate, lithium nickelate, lithium nickel manganese composite oxide, lithium nickel cobalt composite oxide, and the like can be used, and Al, Ti, Zr, Nb, B, W, Mg, Mo, and the like may be added to these lithium transition metal composite oxides.

As the conductive agent, carbon powders such as carbon black, acetylene black, Ketjen black, and graphite may be used alone or in combination of two or more kinds thereof.

Examples of the binder include fluorine-based resins such as polytetrafluoroethylene (PTFE) and polyvinylidene fluoride (PVdF), polyacrylonitrile (PAN), a polyimide-based resin, an acryl-based resin, and a polyolefin-based resin. These may be used alone or in combination of two or more kinds thereof.

The negative electrode 12 includes, for example, a negative electrode current collector and a negative electrode active material layer provided on the negative electrode current collector. As the negative electrode current collector, for example, a foil of a metal such as copper which is stable in a potential range of the negative electrode, a film in which the metal is disposed on a surface layer, or the like can be used. The negative electrode active material layer contains a negative electrode active material, and preferably contains a binder or the like.

As the negative electrode active material, a carbon material capable of occluding and releasing lithium ions can be used, and in addition to graphite, non-graphitizable carbon, graphitizable carbon, fibrous carbon, coke, carbon black, and the like can be used. As a non-carbon-based material, silicon, tin, and an alloy or an oxide mainly containing silicon and tin can be used.

Examples of the binder include a fluorine-based resin, PAN, a polyimide-based resin, an acryl-based resin, a polyolefin-based resin, styrene-butadiene rubber (SBR), nitrile-butadiene rubber (NBR), carboxymethyl cellulose (CMC) or a salt thereof, polyacrylic acid (PAA) or a salt thereof, and polyvinyl alcohol (PVA). These may be used alone or in combination of two or more kinds thereof.

The non-aqueous electrolyte contains a non-aqueous solvent and an electrolyte salt dissolved in the non-aqueous solvent. As the non-aqueous solvent, for example, esters, ethers, nitriles such as acetonitrile, amides such as dimethylformamide, mixed solvents containing two or more kinds thereof, and the like can be used. The non-aqueous solvent may contain a halogen-substituted product obtained by substituting at least some of hydrogen in these solvents with a halogen atom such as fluorine.

Examples of the esters include cyclic carbonate esters such as ethylene carbonate (EC), propylene carbonate (PC), and butylene carbonate, linear carbonate esters such as dimethyl carbonate (DMC), ethyl methyl carbonate (EMC), diethyl carbonate (DEC), methyl propyl carbonate, ethyl propyl carbonate, and methyl isopropyl carbonate, cyclic carboxylate esters such as γ-butyrolactone and γ-valerolactone, and linear carboxylate esters such as methyl acetate, ethyl acetate, propyl acetate, methyl propionate (MP), and ethyl propionate.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers, and linear ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted product, it is preferable to use fluorinated cyclic carbonate esters such as fluoroethylene carbonate (FEC), fluorinated linear carbonate esters, and fluorinated linear carboxylate esters such as methyl fluoropropionate (FMP).

The electrolyte salt is preferably a lithium salt. Examples of the lithium salt include LiBF₄, LiCIO₄, LiPF₆, LiAsF₆, LiSbF₆, LiAlCl₄, LISCN, LiCF₃SO₃, LiCF₃CO₂, Li(P(C₂O₄)F₄), LiPF₆₋ₓ(CₙF₂ₙ₊₁)ₓ(1<x<6, n is 1 or 2), LiB₁₀Cl₁₀, LiCl, LiBr, LiI, chloroborane lithium, lithium lower aliphatic carboxylate, borates such as Li₂B₄O₇ and Li(B(C₂O₄)F₂), and imide salts such as LIN (SO₂CF₃)₂, LIN(C₁F₂ₗ₊₁SO₂) (CₘF₂ₘ₊₁SO₂) {1 and m each represent an integer of greater than or equal to 1}. These lithium salts may be used alone or in combination of two or more kinds thereof as a mixture. Among them, from the viewpoint of ion conductivity, electrochemical stability, and the like, LiPF₆ is preferably used. The concentration of the lithium salt is preferably greater than or equal to 0.8 mol and less than or equal to 1.8 mol per liter of the solvent.

Next, examples will be described, but the present disclosure is not limited to the following examples.

### EXAMPLES

### Example 1

### Production of Positive Electrode

A positive electrode mixture slurry was prepared by mixing 100 parts by mass of a positive electrode active material represented by LiNi_{0.91}Co_{0.04}Al_{0.05}O₂, 1.0 part by mass of acetylene black as a conductive agent, and 0.9 parts by mass of polyvinylidene fluoride as a binder in a solvent of N-methyl-2-pyrrolidone. The positive electrode mixture slurry was applied to both surfaces of an aluminum foil having a thickness of 20 μm, dried, and then rolled by a roll press machine. Thereafter, the obtained member was cut into a predetermined size. In this way, a positive electrode in which a positive electrode active material layer was formed on both surfaces of a positive electrode current collector was obtained.

### Production of Negative Electrode

A negative electrode mixture slurry was prepared by mixing 80 parts by mass of graphite powder, 20 parts by mass of Si oxide, 1 part by mass of carboxymethyl cellulose (CMC), and 1 part by mass of styrene butadiene rubber, and dispersing the mixture in water. The negative electrode mixture slurry was applied to both surfaces of a copper foil having a thickness of 10 μm, dried, and then rolled by a roll press machine. The obtained member was cut into a predetermined size. In this way, a negative electrode in which a negative electrode active material layer was formed on both surfaces of a negative electrode current collector was obtained.

### Production of Separator

A polyolefin-based resin composition was obtained by mixing 100 parts by mass of an ultrahigh-molecular-weight polyethylene resin (weight average molecular weight: 3,000,000, melting point: 136° C.) as a thermoplastic resin, 44 parts by mass of olefin-based wax powder (weight average molecular weight: 1000, melting point: 110° C.) as a thermoplastic resin, and 256 parts by mass of calcium carbonate powder (average particle diameter: 0.2 μm) with a Henschel mixer and kneading the mixture with a twin-screw kneader. The obtained polyolefin-based resin composition was rolled by a roll and molded into a sheet. The obtained polyolefin-based resin composition sheet was immersed in a bath filled with an aqueous hydrochloric acid solution to dissolve and remove calcium carbonate. Thereafter, the polyolefin-based resin composition sheet was washed with water and dried, and then stretched by a tenter stretching machine to obtain a porous polyolefin-based resin composition sheet. This sheet was used as a substrate layer. The thickness of the substrate layer was 0.014 mm.

After 272.65 parts by mass of calcium chloride was dissolved in 4200 parts by mass of N-methyl-2-pyrrolidone, 132.91 parts by mass of paraphenylenediamine was added thereto to be completely dissolved. To the obtained solution, 43.32 parts by mass of terephthalic acid dichloride was gradually added to polymerize para-aramid, and the mixture was further diluted with N-methyl-2-pyrrolidone to obtain a para-aramid solution having a concentration of 2.0 mass %. Alumina powder (average particle diameter: 0.16 μm) was dispersed in the obtained para-aramid solution to obtain a slurry for a heat resistant layer.

A predetermined amount of the slurry for a heat resistant layer was applied to the entire one surface of the substrate layer, and an aramid resin was precipitated in an atmosphere at a temperature of 60° C. and a humidity of 70%. Thereafter, the precipitated aramid resin was washed with water and dried. As a result, a heat resistant layer containing an aramid resin and alumina was formed on the entire one surface of the substrate layer. The slurry for a heat resistant layer was applied onto the heat resistant layer with a predetermined width along the longitudinal direction of the heat resistant layer at the center, in the width direction, of the heat resistant layer. Thereafter, the aramid resin was precipitated in the same manner as described above, washed with water, and dried. The obtained member was slit with a width of 62 mm. In this way, a separator was obtained in which the end heat resistant layers (the first end heat resistant layer and the second end heat resistant layer) formed at both ends, in the width direction, of the heat resistant layer and the central heat resistant layer interposed between the first end heat resistant layer and the second end heat resistant layer were formed on the substrate layer.

In Example 1, the thickness (Y1) of the first end heat resistant layer and the thickness (Y2) of the second end heat resistant layer were each set to 0.0030 mm. In Example 1, the thickness (Z) of the central heat resistant layer was 0.0050 mm. In all of each example and each comparative example, since (Y1) and (Y2) are designed to be the same, (Y1) and (Y2) will be described below as the thickness (Y) of the end heat resistant layer.

The ratio (X1/W) of the length (X1) of the width of the first end heat resistant layer to the length (W) of the width of the separator and the ratio (X2/W) of the length (X2) of the width of the second end heat resistant layer to the length (W) of the width of the separator were each set to 0.19. In all of each example and each comparative example, since (X1/W) and (X2/W) are designed to be the same, (X1/W) and (X2/W) will be described below as a ratio (X/W) of a length (X) of the width of the end heat resistant layer to the length (W) of the width of the separator.

### Preparation of Non-Aqueous Electrolyte Solution

A non-aqueous electrolyte solution was prepared by dissolving 1.5 mol/L of LiPF₆ in a mixed solvent of fluoroethylene carbonate (FEC) and dimethyl carbonate (DMC) (volume ratio: FEC:DMC=1:3).

### Production of Cylindrical Non-Aqueous Electrolyte Secondary Battery

A positive electrode lead was attached to the positive electrode current collector, and a negative electrode lead was attached to the negative electrode current collector. The separator was disposed between the positive electrode and the negative electrode such that the heat resistant layer of the separator faced the positive electrode. Thereafter, these members were wound to produce a winding electrode assembly in which the outermost peripheral surface of the electrode assembly was used as a negative electrode current collector. A first outermost peripheral tape and a second outermost peripheral tape each having a width of 9 mm were wound one turn around one end side and the other end side, in the winding axis direction, of the outermost peripheral surface of the electrode assembly, and attached to the electrode assembly.

In Example 1, the ratio (A1/W) of the length (A1) from one end, in the width direction, of the separator to the central side end, in the width direction, of the first outermost peripheral tape to the length (W), in the width direction, of the separator was set to 0.19, and the entire first outermost peripheral tape was made to face the first end heat resistant layer. The ratio (A2/W) of the length (A2) from the other end, in the width direction, of the separator to the central side end, in the width direction, of the second outermost peripheral tape to the length (W), in the width direction, of the separator was set to 0.19, and the entire second outermost peripheral tape was made to face the second end heat resistant layer. In all of each example and each comparative example, since (A1/W) and (A2/W) are designed to be the same, (A1/W) and (A2/W) will be described below as a ratio (A/W) of a length (A) from the end, in the width direction, of the separator to the central side end, in the width direction, of the outermost peripheral tape to the length (W) of the width of the separator.

Next, insulating plates were each disposed above and under the electrode assembly, the negative electrode lead was welded to the case body, the positive electrode lead was welded to the sealing assembly, and the electrode assembly was accommodated in the case body. After the non-aqueous electrolyte was injected into the case body, the open end of the case body was sealed with a sealing assembly via a gasket. This product was used as a non-aqueous electrolyte secondary battery.

### Example 2

In Example 2, a non-aqueous electrolyte secondary battery was produced in the same manner as in Example 1, except that a separator was produced in which the thickness (Y) of the end heat resistant layer was set to 0.0033 mm and the thickness (Z) of the central heat resistant layer was set to 0.0047 mm.

### Example 3

In Example 3, a non-aqueous electrolyte secondary battery was produced in the same manner as in Example 1, except that a separator was produced in which the ratio (X/W) of the length (X) of the width of the end heat resistant layer to the length (W) of the width of the separator was set to 0.15 and a part of the outermost peripheral tape faced the end heat resistant layer.

### Example 4

In Example 4, a non-aqueous electrolyte secondary battery was produced in the same manner as in Example 1, except that a separator was produced in which the ratio (X/W) of the length (X) of the width of the end heat resistant layer to the length (W) of the width of the separator was set to 0.29.

### Comparative Example 1

In Comparative Example 1, a non-aqueous electrolyte secondary battery was produced in the same manner as in Example 1, except that the first-stage application of applying a predetermined amount of a slurry for a heat resistant layer to the entire one surface of the substrate layer, and a separator was produced in which the thickness (Y) of the end heat resistant layer was set to 0.0040 mm and the thickness (Z) of the central heat resistant layer was set to 0.0040 mm.

### Comparative Example 2

In Comparative Example 2, a non-aqueous electrolyte secondary battery was produced in the same manner as in Example 1, except that the first-stage application of applying a predetermined amount of a slurry for a heat resistant layer to the entire one surface of the substrate layer, and a separator was produced in which the thickness (Y) of the end heat resistant layer was set to 0.0050 mm and the thickness (Z) of the central heat resistant layer was set to 0.0050 mm.

### Comparative Example 3

In Comparative Example 3, a non-aqueous electrolyte secondary battery was produced in the same manner as in Example 1, except that the first-stage application of applying a predetermined amount of a slurry for a heat resistant layer to the entire one surface of the substrate layer, and a separator was produced in which the thickness (Y) of the end heat resistant layer was set to 0.0030 mm and the thickness (Z) of the central heat resistant layer was set to 0.0030 mm.

### Comparative Example 4

In Comparative Example 4, a non-aqueous electrolyte secondary battery was produced in the same manner as in Example 1, except that a separator was produced in which the thickness (Y) of the end heat resistant layer was set to 0.0010 mm.

### Comparative Example 5

In Comparative Example 5, a separator was produced in which the positions of the first outermost peripheral tape and the second outermost peripheral tape were on the central side, in the winding axis direction, of the electrode assembly and the ratio (A/W) of the distance (A) from the end, in the width direction, of the separator to the central side end, in the width direction, of the outermost peripheral tape to the length (W) of the width of the separator was set to 0.29. A non-aqueous electrolyte secondary battery was produced in the same manner as in Example 1, except that such a separator was used.

### Charge/Discharge Cycle Test

The non-aqueous electrolyte secondary battery of each of Examples and Comparative Examples was subjected to constant-current charge (0.3 C, end voltage: 4.2 V)-constant-voltage charge (voltage: 4.2 V, 0.02 C cut) in a temperature environment of 45° C., interrupted for 20 minutes, then subjected to constant-current discharge (0.2 C, end voltage: 2.5 V), and interrupted for 20 minutes. This charge/discharge cycle was performed until the life end (the number of cycles at which the discharge capacity with respect to the discharge capacity of the first cycle was less than or equal to 50%).

The OCV after the discharge of the battery was interrupted during the charge/discharge cycle test was measured, and a case where the OCV rapidly decreased was regarded that an internal short circuit occurred. The results thereof are summarized in Table 1.

The non-aqueous electrolyte battery charged and discharged until the life end was disassembled, and member breakage of the electrode assembly at the outermost peripheral tape end was visually confirmed. The presence or absence of member breakage of the electrode assembly is summarized in Table 1.

TABLE 1

| | | | | | Member breakage of electrode | |
|---|---|---|---|---|---|---|
| | | Y | Z | | assembly at outermost | Internal short |
| | X/W | (mm) | (mm) | A/W | peripheral tape end | circuit |
| Example 1 | 0.19 | 0.003 | 0.005 | 0.19 | None | None |
| Example 2 | 0.19 | 0.0033 | 0.0047 | 0.19 | None | None |
| Example 3 | 0.15 | 0.003 | 0.005 | 0.19 | None | None |
| Example 4 | 0.29 | 0.003 | 0.005 | 0.19 | None | None |
| Comparative Example 1 | 0.19 | 0.004 | 0.004 | 0.19 | Occurred | Occurred |
| Comparative Example 2 | 0.19 | 0.005 | 0.005 | 0.19 | Occurred | None |
| Comparative Example 3 | 0.19 | 0.003 | 0.003 | 0.19 | Occurred | Occurred |
| Comparative Example 4 | 0.19 | 0.001 | 0.003 | 0.19 | None | Occurred |
| Comparative Example 5 | 0.19 | 0.003 | 0.005 | 0.29 | Occurred | None |

X/W: ratio of the length (X) of the width of the end heat resistant layer to the length (W) of the width of the separator
Y: thickness of end heat resistant layer
Z: thickness of central heat resistant layer
A/W: ratio of the length (A) from the end, in the width direction, of the separator to the central side end, in the width direction, of the outermost peripheral tape to the length (W) of the width of the separator

As shown in Table 1, in all Examples 1 to 4, no member breakage of the electrode assembly occurred at the outermost peripheral tape end, and no internal short circuit occurred. In Comparative Examples 1 to 3 and Comparative Example 5, member breakage of the electrode assembly occurred at the outermost peripheral tape end, and in Comparative Examples 1, 3, and 4, internal short circuit occurred. From these results, by making at least a part of the outermost peripheral tape face the end heat resistant layer, making the thickness (Y) of the end heat resistant layer thinner than the thickness (Z) of the central heat resistant layer, and thicker than 0.001 mm, and setting the ratio (A/W) of the distance (A) from the end, in the width direction, of the separator to the central side end, in the width direction, of the outermost peripheral tape to the length (W) of the width of the separator to less than or equal to 0.25, member breakage of the outermost peripheral surface of the electrode assembly due to repetition of charging and discharging is suppressed, and the short-circuit risk can be reduced.

### REFERENCE SIGNS LIST

10 non-aqueous electrolyte secondary battery
11 positive electrode
12 negative electrode
13 separator
14 electrode assembly
14a winding terminal end
15 battery case
16 case body
17 sealing assembly
18, 19 insulating plate
20 positive electrode lead
21 negative electrode lead
22 projecting portion
23 filter
24 lower vent member
25 insulating member
26 upper vent member
27 cap
28 gasket
30a first outermost peripheral tape
30b second outermost peripheral tape
32 substrate layer
34 heat resistant layer
34a first end heat resistant layer
34b second end heat resistant layer
34c central heat resistant layer

1. A non-aqueous electrolyte secondary battery comprising:
a winding electrode assembly formed by winding a positive electrode and a negative electrode with a separator interposed between the positive electrode and the negative electrode; and
an outermost peripheral tape attached to an outermost peripheral surface of the electrode assembly to straddle a winding terminal end of the electrode assembly,
wherein
the separator has a substrate layer and a heat resistant layer disposed on at least one surface of the substrate layer,
the heat resistant layer has a first end heat resistant layer having a predetermined width from one end, in a width direction, of the separator along a winding axis direction of the electrode assembly to a central side, a second end heat resistant layer having a predetermined width from the other end, in the width direction, of the separator along the winding axis direction of the electrode assembly to the central side, and a central heat resistant layer interposed between the first end heat resistant layer and the second end heat resistant layer,
the outermost peripheral tape has a first outermost peripheral tape disposed on one end side, in the winding axis direction, of the electrode assembly and a second outermost peripheral tape disposed on the other end side, in the winding axis direction, of the electrode assembly,
at least a part of the first outermost peripheral tape faces the first end heat resistant layer and at least a part of the second outermost peripheral tape faces the second end heat resistant layer,
a thickness (Y1) of the first end heat resistant layer and a thickness (Y2) of the second end heat resistant layer are thinner than a thickness (Z) of the central heat resistant layer and thicker than 0.001 mm, and
a ratio (A1/W) of a length (A1) from one end, in the width direction, of the separator to a central side end, in the width direction, of the first outermost peripheral tape to a length (W), in the width direction, of the separator, and a ratio (A2/W) of a length (A2) from the other end, in the width direction, of the separator to a central side end, in the width direction, of the second outermost peripheral tape to the length (W), in the width direction, of the separator are each less than or equal to 0.25.

2. The secondary battery according to claim 1, wherein the entire first outermost peripheral tape faces the first end heat resistant layer, and the entire second outermost peripheral tape faces the second end heat resistant layer.

3. The secondary battery according to claim 1, wherein a ratio (Z/Y1) of a thickness (Z) of the central heat resistant layer to the thickness (Y1) of the first end heat resistant layer, and a ratio (Z/Y2) of the thickness (Z) of the central heat resistant layer to the thickness (Y2) of the second end heat resistant layer are each greater than or equal to 1.4.

4. The secondary battery according to claim 1, wherein the ratio (A1/W) of the length (A1) from one end, in the width direction, of the separator to the central side end, in the width direction, of the first outermost peripheral tape to the length (W), in the width direction, of the separator, and the ratio (A2/W) of the length (A2) from the other end, in the width direction, of the separator to the central side end, in the width direction, of the second outermost peripheral tape to the length (W), in the width direction, of the separator are each greater than or equal to 0.10 and less than or equal to 0.25.

5. The secondary battery according to claim 1, wherein the thickness (Z) of the central heat resistant layer is greater than or equal to 0.0045 mm.

6. The secondary battery according to claim 1, wherein a ratio (X1/W) of a length (X1) of the predetermined width of the first end heat resistant layer to the length (W), in the width direction, of the separator, and a ratio (X2/W) of a length (X2) of the predetermined width of the second end heat resistant layer to the length (W), in the width direction, of the separator are each greater than or equal to 0.10 and less than or equal to 0.25.
